(19) United States
(12) Patent Application Publication
(10) Pub. No.: US 2009/0059634 A1
(43) Pub. Date: Mar. 5, 2009

(54) Switching power supply

(75) Inventor: Tetsushi Otake, Tsurugashima-shi (JP)

Correspondence Address: RENNER KENNER GREIVE BOBAK TAYLOR & WEBER, FIRST NATIONAL TOWER FOURTH FLOOR, 106 S. MAIN STREET, AKRON, OH, 44308, US

(73) Assignee: TOKO, INC., Tokyo-to (JP)

(21) Appl. No.: 12/229,301

(22) Filed: Aug. 21, 2008

(30) Foreign Application Priority Data
Aug. 31, 2007 (JP) JP 2007-225382

(51) Int. Cl. H02M 7/5387

(52) U.S. Cl. 363/132

(57) ABSTRACT

To provide a half-bridge switching power supply using a series resonance that can realize both of a smaller size and higher reliability of a device.

In a half-bridge switching power supply including two switching elements and an LC resonant circuit including an inductor and capacitors for the series resonance, two switching elements Q1 and Q2 constituting the half bridge, a series-resonant inductor Lp, and two capacitors Co1 and Co2 for a series-resonant capacitor are used.

### BACKGROUND OF THE INVENTION

1. Field of the Invention

The present invention relates to a half-bridge switching power supply using a series resonance.

2. Related Art

As a switching power supply using a series resonance that is used for a conventional cold-cathode lighting device such as a cold-cathode lighting fluorescent lamp (CCFL), a half-bridge switching power supply illustrated in FIG. 3 is widely known (refer to Japanese Patent Laid-Open No. 3-89493).

FIG. 3 illustrates the half-bridge switching power supply including two switching elements Q1 and Q2, an inductance Lp of a transformer T and a resonant capacitor Co for the series resonance, half bridge capacitors C1 and C2, and a pulse signal generator that performs a switching control on the two switching elements Q1 and Q2.

In the circuit described above the resonant capacitor Co is, for example, a film capacitor having a high Q factor and good frequency characteristic. Since a large amount of AC current flows through the half bridge capacitors C1 and C2, they are electrolytic capacitors that afford a large amount of current.

However, the electrolytic capacitor has a problem of reliability such as a change of capacitance due to self-heating and temperature, while having large allowable current and capacitance, compared to other capacitors.

Particularly, the electrolytic capacitors C1 and C2 constituting a half bridge need to have an impedance Zc extremely lower than an impedance Zo of the resonant capacitor Co and an inductance Lp in a series-resonant state, that is, Zc<<Zo.

This impedance Zc is represented as a following expression.

Zc=r/ωC

(herein, “r” represents an equivalent series resistance of the electrolytic capacitor) Accordingly, the electrolytic capacitor is to be as much as several thousands μF or larger capacitance in general. Further, the equivalent series resistance of the electrolytic capacitors is larger than that of other capacitors. Since the electrolytic capacitor generates heat that amounts to the equivalent series resistance multiplied by a square of the current flowing through the capacitor, the electrolytic capacitor also generates a large amount of self-heating.

As described above, if the electrolytic capacitor is used for the capacitor constituting the half bridge, the electrolytic capacitor needs to have a large capacitance. Moreover, considering an impact of self-heating of the electrolytic capacitor by a ripple current, the electrolytic capacitor needs to be further larger in size, thereby hindering the size of a device to be reduced.

The present invention addresses the problem described above. An object of the present invention is to provide a half-bridge switching power supply using series resonance that can realize both a smaller size and higher reliability of the device.

### SUMMARY OF THE INVENTION

A half-bridge switching power supply of the present invention includes two switching elements and an LC resonant circuit including an inductor and capacitors for a series resonance. The two capacitors constituting a half bridge are used for a series-resonant capacitor.

### BRIEF DESCRIPTION OF THE DRAWINGS

FIG. 1 is a circuit diagram illustrating a switching power supply that is an embodiment of the present invention;

FIGS. 2A and 2B are an explanatory diagram illustrating a switching operation in the embodiment illustrated in FIG. 1; and

FIG. 3 is a circuit diagram illustrating a generally-used switching power supply using a half bridge.

According to a switching power supply of the present invention, the switching power supply includes two switching elements and an LC resonant circuit including an inductor and capacitors for a series resonance, wherein two capacitors constituting a half bridge are used as the series-resonant capacitor, thereby providing the switching power supply that facilitates a smaller size and higher reliability thereof.

### DETAILED DESCRIPTION OF THE INVENTION

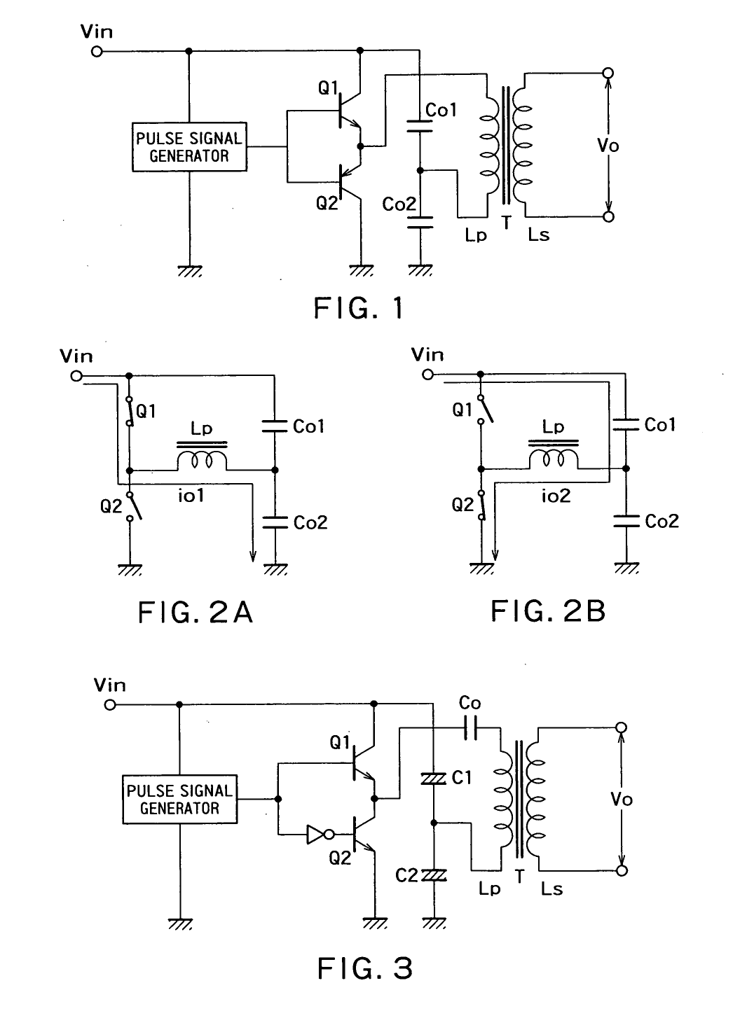

With reference to FIGS. 1 and 2, an embodiment of the present invention will be described.

FIG. 1 is a circuit diagram illustrating the embodiment of the present invention. As illustrated in FIG. 1, a half-bridge switching power supply includes two switching elements and an LC resonant circuit including an inductor and capacitors for a series resonance.

In FIG. 1, two switching elements Q1 and Q2 connected in series and two resonant capacitors Co1 and Co2 connected in series constitute a series circuit. A common connecting point of the resonant capacitors Co1 and Co2 is connected to one end of an inductor Lp (series-resonant inductor) of a transformer T. Further, the other end of the inductor Lp is connected to a common connecting point of the two switching elements Q1 and Q2.

The switching element Q1 and the capacitor Co1 are connected to an input Vin, and the switching element Q2 and the capacitor Co2 are connected to a ground so that an electric power is applied to the two switching elements Q1 and Q2 connected in series and the two resonant capacitors Co1 and Co2 connected in series.

Furthermore, a pulse signal generator that performs a switching control on the two switching elements Q1 and Q2 is connected to a base of the two switching elements Q1 and Q2 to constitute the half-bridge switching power supply that generates a high-frequency output from a secondary side Ls of the transformer T.

An operation of the device configured as described above will be described with reference to FIG. 2.

FIG. 2A illustrates a state of resonance in which the switching element Q1 is “On” and the switching element Q2 is “Off”. Contrary to FIG. 2A, FIG. 2B illustrates a state of resonance in which the switching element Q1 is “Off” and the switching element Q2 is “On”. Here, the series resonance is generated between the inductor Lp of the transformer T illustrated in FIG. 1 and either one of the resonant capacitors Co1 and Co2.

As illustrated in FIG. 2A, when the switching element Q1 is On and the switching element Q2 is Off, a current io1 flows from an input Vin through a path including the switching element Q1, the inductor Lp and the capacitor Co2. The series-resonant circuit here includes the inductor Lp of the transformer T and the capacitor Co2.

As illustrated in FIG. 2B, contrary to FIG. 2A, when the switching element Q1 is “Off” and the switching element Q2 is “On”, a current io2 flows from the input Vin through a path including the capacitor Co1, the inductor Lp, and the switching element Q2. The series-resonant circuit here includes the inductor Lp of the transformer T, and the capacitor Co1.

As described above, the currents io1 and io2 flow through the inductor Lp as illustrated in FIGS. 2A and 2B by turning the switching elements Q1 and Q2 “On” and “Off” so that high-frequency output can be generated at the secondary side Ls of the transformer T.

Now, as with the conventional resonant capacitor Co, when Co1 and Co2 are set equally to Co, resonant frequencies Fo1 and Fo2 are generated as sine waves having frequencies of the following expression.

Fo1, Fo2=1/(2n√(Lp×Co1)=1/2n√(Lp×Co2))

With the switching power supply of the present invention, in the case where the resonant frequencies Fo1 and Fo2 are set to 100 KHz, it is possible to use the inductor Lp of 2.5 μH and the resonant capacitors Co1 and Co2 having a capacitance of 1 μF, which can be a film capacitor for high frequency having a small equivalent series resistance, small size, high Q factor and good frequency characteristic.

A bipolar transistor or a metal-oxide semiconductor field-effect transistor (MOSFET) may be used for the switching element. Further, combinations of two switching elements may be P type and P type, N type and N type, P type and N type, or N type and P type. Note that, when the same types of switching elements are combined, an inverter circuit needs to be provided at one of the switching elements as illustrated in FIG. 3 to change the polarity.

As described above, the switching power supply of the present invention does not need to have the electrolytic capacitor having a large size and capacitance otherwise used for a half bridge, but uses the capacitor having a small size used for the half bridge as well as for the series resonance. Accordingly, the electrolytic capacitor is not necessary for the switching power supply. Thus the present invention can provide the switching power supply that can realize the smaller size and higher reliability of the device by using the high-frequency capacitor having the small equivalent series resistance.

What is claimed is:

1. A switching power supply of half-bridge type comprising two switching elements and an LC resonant circuit including an inductor and capacitors for a series resonance,
wherein two capacitors constituting a half bridge are used for a series-resonant capacitor.

2. The switching power supply according to claim 1, wherein film capacitors having same capacitance values are used for the two series-resonant capacitors.

3. The switching power supply according to claim 1, wherein a bipolar transistor or a MOSFET is used for the two switching elements.
